(19) United States
(12) Patent Application Publication
(10) Pub. No.: US 2024/0197563 A1
(43) Pub. Date: Jun. 20, 2024

(54) POOL HUB APPARATUS AND METHODS

(71) Applicant: Belgravia Wood Limited

(72) Inventors: Kevin ZHANG, Dongguan (CN); Will JIN, Dongguan (CN); Ricky TONG, Shenzhen (CN); Eric SZWEDA, Hong Kong (CN); Paul Olsen, Stuart, FL (US); Jaime RAMOS, Moorpark, CA (US)

(73) Assignee: Belgravia Wood Limited, (US)

(21) Appl. No.: 18/566,565

(22) PCT Filed: Jun. 6, 2022
(86) PCT No.: PCT/US2022/072782

§ 371 Date: Dec. 1, 2023

Related U.S. Application Data
(60) Provisional application No. 63/202,301, filed on Jun. 4, 2021.

(51) Int. Cl. A61H 33/00; E04H 4/08; E04H 4/12; E04H 4/14; E04H 4/16; H02H 3/16

(52) U.S. Cl. CPC A61H 33/0095; A61H 33/0087; E04H 4/08; E04H 4/1245; E04H 4/129; H02H 3/162; A61H 2033/0037; A61H 2033/0083; A61H 2201/0207; A61H 2201/5012; A61H 2201/5082; E04H 4/144; E04H 4/148; E04H 4/16

(57) ABSTRACT

Embodiments of the present disclosure provide systems and methods for a pool hub. The pool hub may include a primary electrical system, a pump, a secondary electrical system that receives power from the primary electrical system; a converter; and an electrical outlet that receives power from the secondary electrical system; where the converter distributes power from the primary electrical system to the secondary electrical system. A number of sensors and/or devices associated with a pool may be powered via the secondary electrical system.

### FIELD OF THE INVENTION

The presently disclosed subject matter generally relates to systems and methods for pool skimmers and pump and a supply of power at a pool to supply power to a number of devices.

### BACKGROUND

A variety of pool skimmers and pumps are known. Pool skimmers are a variety of devices for removing debris and unwanted particles from a top of a fluid. Pool pumps are a variety of devices for pumping water to remove debris and unwanted particles from beneath the surface of a fluid. Pool skimmers and pumps, for example, include filters that water may be drawn or pumped through so that the debris and unwanted particles are trapped. As the water passes through the skimmer or pump, chemicals such as chlorine may be introduced into the water to treat the water, for example, for bacteria and to affect the pH level.

The pool may be an above-ground pool or an in-ground pool. The above-ground pool may include a frame surrounding a liner holding a fluid, where the frame and the fluid are at least partially above a ground surface. In some embodiments, the above-ground pool may include an inflatable structure configured to contain the fluid. In some embodiments, the above-ground pool or the in-ground pool may be a spa. The in-ground pool may include a liner that contains a fluid. The fluid may be used for recreation or training. The use of electrical powered devices, such as pool skimmers and pumps, present challenges for keeping electricity associated with the devices apart from the fluid to avoid risks to pool inhabitants.

Known pool skimmers and pumps, and other pool devices, generally are designed with isolated electrical systems for each device and do not present opportunities to connect electrical power to other devices. For example, a pool pump may be powered by a separate or isolated electrical connection. Such devices cannot provide power to other devices associated with a pool, which may include a pool vacuum, a speaker system, a refrigerator, sensors, lights, or a number of other electrically-powered devices. An extension cord from a power supply that might power these devices near a pool presents a number of issues including the potential for electrical danger, trip hazards, and aesthetic problems among others. Additionally, it is desirable to have a single unit that powers and/or controls a number of different devices associated with the pool.

### SUMMARY

Briefly described, embodiments of the presently disclosed subject matter relate to systems and methods for a pool hub.

An exemplary aspect of this disclosure relates to a pool hub comprising a power hub configured to receive electric power, a pump configured to receive electric power from the power hub, wherein the pump is configured to seal fluid from the power hub, and an electrical outlet configured to receive electric power from the power hub, wherein the electrical outlet is configured to provide power to an electronic accessory.

According to some embodiments, the power hub may comprise a ground fault circuit interrupter. According to some embodiments, the electrical outlet may comprise a ground fault circuit interrupter. According to some embodiments, the electronic accessory may comprise an electrically-powered retractable roof. According to some embodiments, the electronic accessory may comprise a retractable ladder. According to some embodiments, the electronic accessory comprises a charging base. According to some embodiments, the power hub may receive powered from a solar panel. According to some embodiments, the solar panel may comprise a pool cover. According to some embodiments, the electronic accessory may comprise a temperature sensor configured to sense a temperature of water in the pool. According to some embodiments, the electronic accessory may comprise a sensor configured to indicates a movement associated with an object in the pool or a fluid of the pool. According to some embodiments, the electronic accessory may comprise an acidity sensor configured to senses an acidity of water in the pool. According to some embodiments, the electronic accessory may comprise a light that indicates the acidity of water in the pool. According to some embodiments, the electronic accessory may comprise a light that indicates a filter status. According to some embodiments, the pool hub may comprise a skimmer. According to some embodiments, the pool hub may comprise a heating element.

According to some embodiments, the pool hub may comprise a controller that sends or receives information from the pump. According to some embodiments, the controller may be configured to communicate remotely with a network device. According to some embodiments, the controller may be configured to receive instructions from the network device. According to some embodiments, the electronic accessory may comprise an air supply station.

An aspect of this disclosure relates to a pool hub comprising a primary electrical system configured to provide electrical power to a pump, a secondary electrical system configured to receive electrical power from the primary electrical system, a converter, and an electrical outlet configured to receive power from the secondary electrical system, wherein the converter distributes power from the primary electrical system to the secondary electrical system. According to some embodiments, the primary electrical system may comprise a 120/240V system or a 110V/220V system. According to some embodiments, the primary electrical system may comprise a direct current system. According to some embodiments, the primary electrical system may comprise a battery. According to some embodiments, the secondary electrical system may comprise a 12V system. According to some embodiments, the secondary electrical system may comprise a controller that sends or receives information from an electronic accessory. According to some embodiments, the controller may be configured to communicate remotely with a network device. According to some embodiments, the controller may be configured to receive instructions from the network device. According to some embodiments, the pump may be configured to physically and electrically connect to a skimmer. According to some embodiments, the secondary electrical system may be insulated from the primary electrical system. According to some embodiments, the pump may comprise a filter. According to some embodiments, the secondary electrical system may comprise a light. According to some embodiments, the secondary electrical system may comprise a sound device. According to some embodiments, the primary electrical system may comprise a light. According to some embodiments, the pump may comprise an alarm. According to some embodiments, the pump may comprise a vacuum. According to some embodiments, the pump may comprise a jet system. According to some embodiments, the secondary electrical system may comprise a light that interacts with the jet system.

The foregoing summarizes only a few aspects of the presently disclosed subject matter and is not intended to reflect the full scope of the presently disclosed subject matter as claimed. Additional features and advantages of the presently disclosed subject matter are set forth in the following description, may be apparent from the description, or may be learned by practicing the presently disclosed subject matter. Moreover, both the foregoing summary and following detailed description are exemplary and explanatory and are intended to provide further explanation of the presently disclosed subject matter as claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this specification, illustrate multiple embodiments of the presently disclosed subject matter and, together with the description, serve to explain the principles of the presently disclosed subject matter; and, furthermore, are not intended in any manner to limit the scope of the presently disclosed subject matter.

FIGS. 1A and 1B illustrate a pool hub according to some embodiments of the present disclosure.

FIG. 2 illustrates a pool hub according to some embodiments of the present disclosure.

FIGS. 3A and 3B illustrate a pool hub according to some embodiments of the present disclosure.

FIGS. 4A-4E illustrate an above-ground pool according to some embodiments of the present disclosure.

FIGS. 5A-5F illustrate pool hubs according to some embodiments of the present disclosure.

FIG. 6 illustrates a pool connection according to some embodiments of the present disclosure.

FIG. 7 illustrates a pool assembly according to some embodiments of the present disclosure.

FIGS. 8A and 8B illustrate a pool hub according to some embodiments of the present disclosure.

FIGS. 9-9C illustrate pool hubs according to some embodiments of the present disclosure.

### DETAILED DESCRIPTION

Reference will now be made in detail to exemplary embodiments, some examples of which are shown in the accompanying drawings.

To facilitate an understanding of the principles and features of the invention, various illustrative embodiments are explained below. In particular, the presently disclosed subject matter is described in the context of systems and methods for the operation of a pool hub.

Exemplary disclosed embodiments include apparatus, systems, and methods for providing electrical power and controlling apparatuses through a pool hub. For example, in some embodiments, the pool hub may include one or more of a pool pump or a pool skimmer. The pool hub may include a pool vacuum. The pool hub may include a number of compartments that contain a number of devices. The compartments may be sealable against water and other fluid elements. The pool hub may include a number of electrical outlets to connect the number of devices. The pool hub may include electrical outlets including a higher voltage system and a lower voltage system. The higher voltage system may power devices such as a pool pump, a pool skimmer, a pool jet, a water heater, a refrigerator, or a number of other devices. The lower voltage system may power devices such as an electrical communication device, a screen, a speaker, a sensor, or a number of other devices. The pool hub may be attachable to an above-ground pool or an in-ground pool. In some embodiments, the above-ground pool or the in-ground pool may include a spa. In some embodiments, the pool hub may stand on a base and be physically separated from an above-ground pool or an in-ground pool.

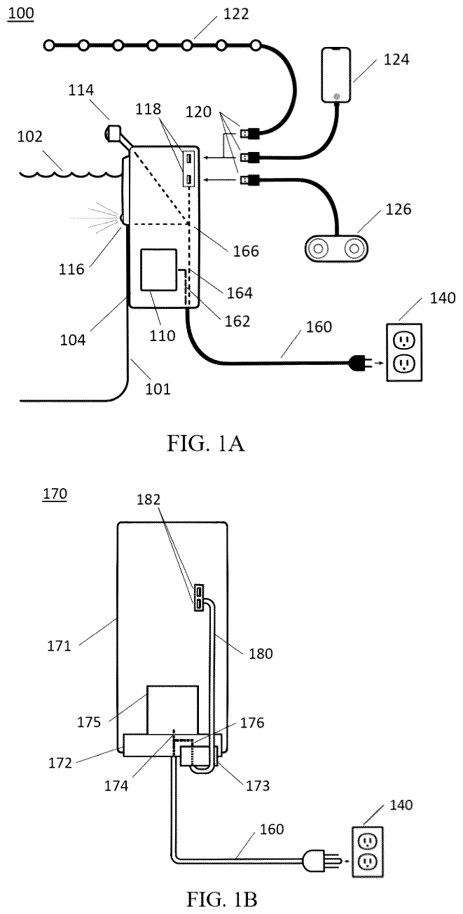

Referring now to the figures, wherein like reference numerals represent like parts throughout the views, the pool liner will be described in detail. FIG. 1A illustrates a pool and a pool hub according to some embodiments of the present disclosure.

Specifically, FIG. 1A illustrates exemplary pool assembly 100 in accordance with some embodiments of the present disclosure. Pool assembly 100 may include fluid 102 contained within pool wall 101. Pool wall 101 may include a liner. Pool assembly 100 may include pool hub 104. In some embodiments, pool hub 104 may be attached to a pool wall 101. For example, pool hub 104 may be attached to a frame of pool wall 101 in the case of an above-ground pool. As another example, pool hub 104 may be located in an enclosure adjacent to pool wall 101 in the case of an in-ground pool.

Pool hub 104 may include a number of electrical devices and/or may include an outlet for the number of electrical devices or other electrical devices. Pool hub 104 may include pump 110. Pump 110 may be sealed from one or more other elements of pool hub 104 including power-receiving components. Pool hub 104 may include electrical connection 160. Electrical connection 160 may form a wired circuit with outlet 140 and one or more devices of pool hub 104. Electrical connection 160 may connect to an outlet 140. In some embodiments, outlet 140 may be connected to an electrical grid such as a wide area synchronous grid. In some embodiments, outlet 140 may be an outlet may be connected to one or more solar panels. In some embodiments, a cover of a pool may include solar panels.

In some embodiments, outlet 140 may be connected to a mobile generator include a fuel-powered generator or a vehicle configured to produce power to internal or external connections. In some embodiments, outlet 140 and electrical connection 160 may conduct alternating current. In some embodiments, outlet 140 and electrical connection 160 may conduct direct current. Outlet 140 may be configured to open a circuit, thereby discontinuing the flow of current, for example when a ground fault condition exists such as when the difference in an amount of output current exceeds an amount of input current. This may occur when electricity follows an unintended path instead of within a wired circuit, for example, when conducted to a different ground than one associated with the wired circuit. In some embodiments, outlet 140 may include a ground fault circuit interrupter (GFCI). Additionally or alternatively, outlet 140 may be connected to a circuit breaker GFCI. Additionally or alternatively, outlet 140 may be connected to a temporary or portable GFCI. Outlet 140 may contain a switch configured to connect and/or disconnect power from outlet 140.

Electrical connection 160 may connect to first internal connection 162 and second internal connection 164. Electrical connection 160 may be wired to split once inside an enclosure of pool hub 104. In some embodiments, electrical connection 160 may connect to a junction configured to split power to one or more devices. In such embodiments, the junction may be configured to open a circuit, thereby discontinuing the flow of current, when a ground fault condition exists. First internal connection 162 may connect to and supply power to pump 110. Second internal connection 164 may connect to junction 166. In some embodiments, electrical connection 160 may include a switch configured to connect and/or disconnect power downstream to pool hub 104.

Junction 166 may split a power provided from second internal connection 164 such that power is provided to a number of devices, such as sensor 114, pool interface 116, light 122, communication device 124, and speaker 126. Junction 166 may be configured to open a circuit, thereby discontinuing the flow of current, for example when a ground fault condition exists. Junction 166 may include a processor. The processor may process instructions stored on one or more memory devices. The processor may be configured to open or close a circuit that provides power to the number of devices. Junction 166 may include a communication device to communicate to a number of devices. The processor may send and/or receive instructions to the communication device. The communication device may communicate via a cellular connection, a wireless connection, a short-range communication connection such as a Bluetooth connection, a wired internet connection, or another communication method. One or more of the number of devices may be connected to junction 166 via outlets 118. One or more of outlets 118 may be used to connect power and/or data of one or more devices to junction 166. The processor may send and/or receive instructions to one or more devices through one or more of outlets 118. Plugs 120 may be used to connect power and/or data to a number of devices to outlets 118. Outlets 118 and plugs 120 may use known connections for transmitting power and/or data including USB 1.0, USB 2.0, USB 3.0, USB-C, micro USB, or any connection used for transmitting power and/or data.

Junction 166 may include a converter to convert a higher power to a lower power. The higher power may be power from an electrical grid which may be provided, for example, as an alternating current at approximately 120 Volts and 15 Amps or 20 Amps. As another example, power from an electrical grid may be provided as an alternating current at approximately 110 Volts and 15 Amps or 20 Amps. The lower power may be provided as a direct current at approximately 5 Volts to 12 Volts and 0.5 Amps to 5 Amps. Other higher power and lower power configurations are contemplated. The lower power may be of a voltage and a current such that any conductivity through fluid 102 would not be harmful to any persons withing fluid 102. The lower power circuit may include a switch configured to open and close the circuit. The lower power circuit may open a circuit, thereby discontinuing the flow of current, for example when a ground fault condition exists such as when the difference in an amount of output current exceeds an amount of input current.

Sensor 114 may be configured to determine the presence of objects in fluid 102. Sensor 114 may be configured to determine the presence of one or more persons in fluid 102. In some embodiments, sensor 114 may include an infrared sensor that determines the presence of a person or an object. Other types of sensors may be used such as LIDAR sensors, sonar sensors, or any other sensor to sense a person or an object. In some embodiments, sensor 114 may measure movement of fluid 102.

Pool interface 116 may include an inlet and/or outlet such that fluid from fluid 102 may be sent and/or received to and/or from pump 110. One or more filters may be within pool interface 116. Pool interface 116 may include a receptacle configured to receive chemicals that may be mixed into fluid 102. Pool interface 116 may include a number of devices such as a light, a pH sensor, a bacteria sensor, a chemical sensor, and/or a temperature sensor. The number of devices of pool interface 116 may send and receive power and/or data to and from junction 166.

Speaker 126 may include one or more speakers. Speaker 126 may receive power and/or data through outlet 118. In some embodiments, speaker 126 may receive power through outlet 118 and data from an external device. Communication device 124 may be a cellular device. Communication device 124 may receive power and/or data through outlet 118. Communication device 124 may communicate with one or more processors of pool hub 104. Communication device 124 may include an application to provide instructions to the one or more processors and/or receive information from the one or more processors. For example, communication device 124 may provide instructions to a processor of junction 166 to turn a light of pool interface 116 on and off. Light string 122 may include a number of lights for aesthetics and/or safety.

It is contemplated that the number of devices may be connected internally to junction 166 and enclosed by a structure of pool hub 104. It is contemplated that the number of devices may be connected through outlets 118. Although several connected devices are discussed with reference to FIG. 1A, several devices are contemplated. For example, pool hub 104 may be externally or internally connected to a heating element configured to provide heat to fluid 102. As another example, pool hub 104 may be externally or internally connected to a charger for one or more devices such as a communication device, a lawn mower, and a pool vacuum. As another example, pool hub 104 may be externally or internally connected to a refrigerator, a powered umbrella, a powered roof, a water jet, or other operation apparatuses. As another example, pool hub 104 may be externally or internally connected to a display. In some embodiments, the display may provide an interface with pool hub 104 and one or more components or apparatuses connected to pool hub 104. One or more other components may be combined into a sub-assembly. The sub-assembly may be physically and/or electrically connectable to pool hub 104. It is also contemplated that pool hub 104 may include a switch for connecting or disconnecting one or more circuits of pool hub 104.

FIG. 1B illustrates exemplary pool hub assembly 170, in accordance with some embodiments of the present disclosure. Certain features of pool hub assembly 170 are not shown or discussed in these examples where such features may be similar to those discussed for other embodiments. Pool hub assembly 170 may include electrical connection 160 to connect to outlet 140. Electrical connection 160 may provide electrical energy to pool hub 171. Pool hub 171 may include power hub 172. At power hub 172, received power from electrical connection 160 may be transmitted to a number of power-receiving components of pool hub 171. Power hub 172 may include features and components similar to those of junction 166 described above. Power hub 172 may include internal electrical connection 174 that provides electrical energy to pump 175. Power hub 172 may include second internal electrical connection 176 that provides electrical energy to converter 178. Converter 173 may convert a higher power to a lower power. Converter 173 may include external electrical connection 180 that provides electrical energy to outlets 182. Outlets 182 may be mounted adjacent to a body of pool hub 171. In some embodiments, outlets 182 may be mounted away from pool hub 171, such as on a pool frame (not shown in FIG. 1B). It is contemplated that outlets 182 may include a first outlet configured to output a higher power and a second outlet configured to output lower power consistent with the present disclosure.

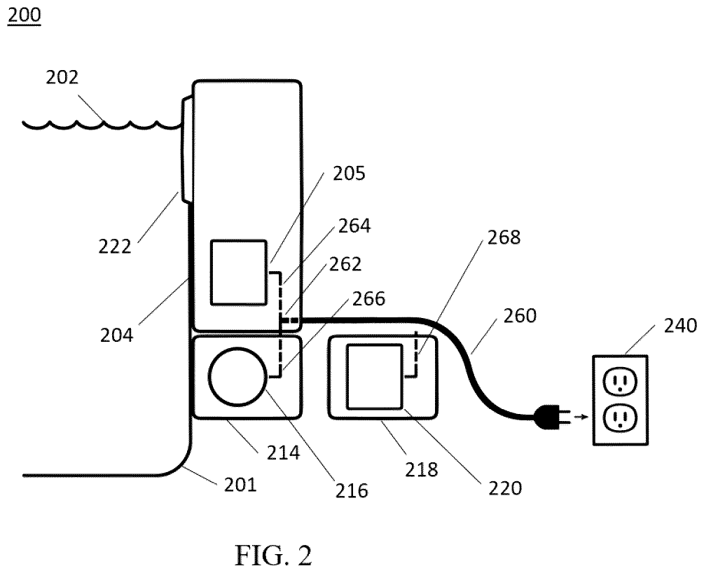

FIG. 2 illustrates another exemplary pool assembly 200, in accordance with some embodiments of the present disclosure. Certain features of pool assembly 200 are not shown or discussed in these examples where such features may be similar to those discussed for other embodiments. Pool assembly 200 may include fluid 202 contained within pool wall 201. Pool wall 201 may include a liner. Pool assembly 200 may include pool hub 204. Pool hub 204 may include inlet 222. Pool hub 204 may include first pump 205.

Pool assembly 200 may include first module 214 and/or second module 218. First module 214 and second module 218 may be powered by electrical connection 260 that connects to outlet 240. First module 214 may include a pump configured to pump water beneath a surface of fluid 202. First module 214 may include second pump 214. Electrical connection 260 may be connected to junction 262. Junction 262 may include separating electrical connection 260 into first electrical connection 264 and second electrical connection 266. In some embodiments, junction 262 may include separating electrical connection 260 into third electrical connection 268. First electrical connection 264 may connect electrical connection 260 to first pump 205. Second electrical connection 266 may connect electrical connection 260 to second pump 216. Third electrical connection 268 may connect electrical connection 260 to charger 220. Charger 220 may include a charger for other devices, such as one or more of a communication device, a lawn mower, and a pool vacuum. In some embodiments, other external apparatuses may be electrically and/or physical attached to pool hub 204 such as air pump configured to supply air to an air-receiving apparatus such as a float or a balloon, a water jet configured to supply water to clean items or to wash a user's feet, a water heater, a retractable roof, a retractable umbrella, or other pool operation apparatuses. In some embodiments, junction 262 may be similar to junction 166 as discussed with reference to FIG. 1.

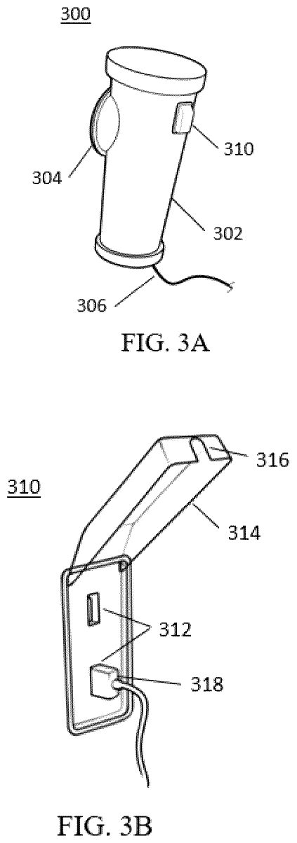

FIGS. 3A and 3B illustrate another exemplary hub assembly 300, in accordance with some embodiments of the present disclosure. Certain features of hub assembly 300 are not shown or discussed in these examples where such features may be similar to those discussed for other embodiments. Hub assembly 300 may include pool hub 302. Pool hub 302 may include pool interface 304, electrical connection 306, and outlet assembly 310. Outlet assembly 310 may include one or more features to prevent a fluid and/or debris from reaching outlets 312. Outlet assembly 310 may include cover 314. Cover 314 may include slot 316. Outlet assembly 310 may connect to chord 318. Slot 316 may provide an opening for chord 318 to pass from outside of cover 314 to inside cover 314. Cover 314 may move around a connection to pool hub 302 such that cover 314 seals or partially seals against a surface of pool hub 302. Outlets 312 may be positioned relatively horizontally such that the fluid is diverted from and/or does not settle into outlets 312. Outlets 312 may be positioned on a surface facing away from the fluid such that fluid is less likely to accumulate on a surface associated with outlets 312. In some embodiments, outlets 312 may be positioned on a surface at least partially directed downwards towards a ground surface such that fluid is diverted from and/or does not settle on and/or inside outlets 312. In some embodiments, outlets 312 may include a drain that may include a hole at least partially passing through an outlet such that fluid is diverted and/or does not settle on and/or inside outlets 312.

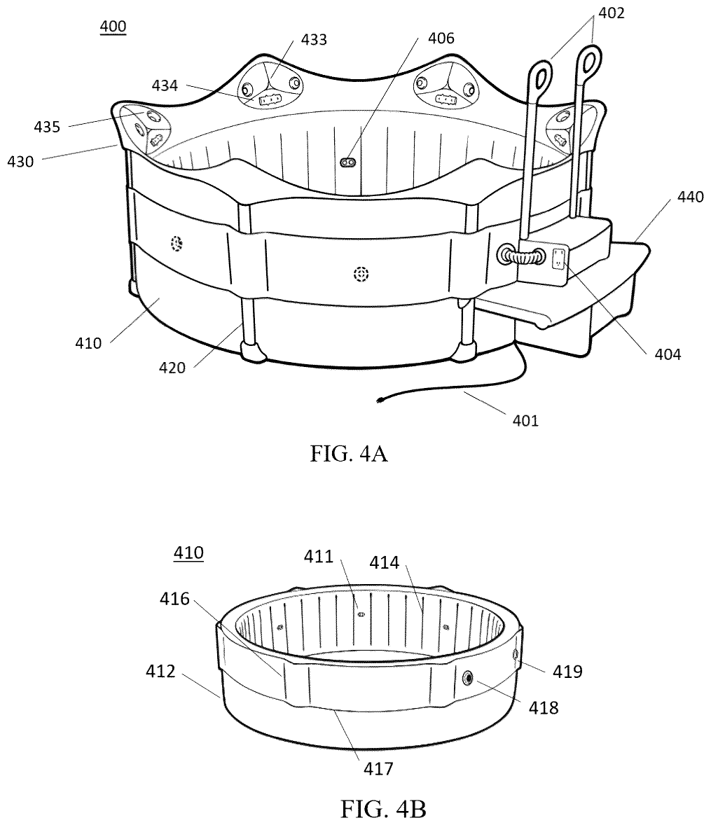

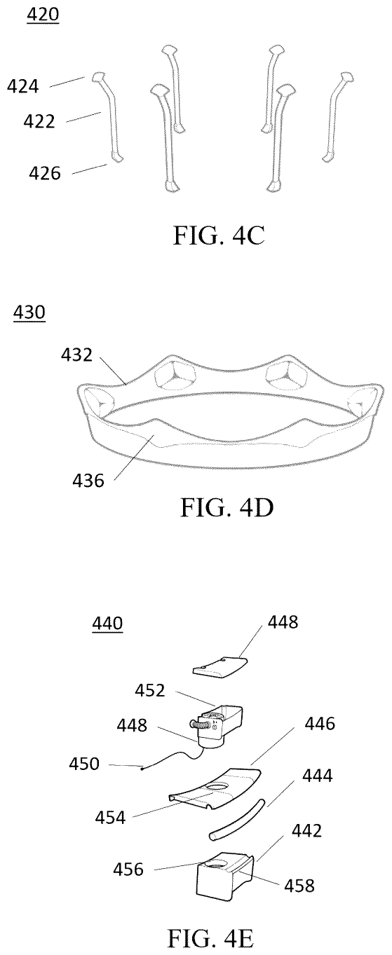

FIGS. 4A-4E illustrate another exemplary pool assembly 400, in accordance with some embodiments of the present disclosure. Certain features of pool assembly 400 are not shown or discussed in these examples where such features may be similar to those discussed for other embodiments.

FIG. 4A illustrates exemplary pool assembly 400. Pool assembly 400 may include one or more of electrical connection 401, handles 402, outlets 404, jet 406, liner assembly 410, frame 420, upper liner assembly 430, and step assembly 440. Step assembly 440 may include a pool hub. Electrical connection 401 may provide electrical power to one or more components of pool assembly 400 including a pool hub, jet 406, components of upper liner assembly 430, and outlets 404. Jet 406 may pump water through outlets in the interior of a liner of liner assembly 410 for aesthetic purposes and/or to provide a massage.

FIG. 4B illustrates exemplary liner assembly 410. Liner assembly 410 may include openings 411, outside liner 412, inside liner 414, frame wrap 416, inlet 418, and outlet 419. Openings 411 may be openings for jets as described above such as jet 406. Outside liner 412 may provide a barrier between external elements such as mildew and weather and components within outside liner 412. Inside liner 414 may contain a volume of liquid. Outside liner 412 and inside liner 414 may be formed from a single sheet. Outside liner 412 and inside liner 414 may be attached. Inside liner 414 may include padding and/or resting surfaces to support a user. Frame wrap 416 may be attached to outside liner 412 and wrap around one or more frame elements. Frame wrap 416 may be configured to provide structural support to outside liner 412. Inlet 418 may provide a first path for liquid to leave an interior of a pool and enter a filter and/or a pool hub. Outlet 419 may provide a second path for liquid to leave the filter and/or the pool hub and enter the interior of the pool. Inlet 418 and outlet 419 may pass through both outside liner 412 and inside liner 414.

FIG. 4C illustrates exemplary frame 420. Frame 420 may include one or more supports 422. Supports 422 may be substantially vertical. Supports 422 may include one or more interfaces that connect to other portions of frame 420 and/or liner assembly 410. Supports 422 may be configured to transmit weight of pool assembly 400 and liquid and occupants within pool assembly 400 to a ground surface. Supports 422 may include first liner interface 424 and second liner interface 426. First liner interface 424 may include a surface with width to support at least a portion of upper liner assembly 430. Second liner interface 426 may connect to portions of a frame 420 that are substantially adjacent to a ground surface. In some embodiments, second liner interface 426 may be inserted into a ground surface.

FIG. 4D illustrates exemplary upper liner assembly 430. Upper liner assembly 430 may include liner 432. Liner 432 may include one or more pockets 436. Pockets 436 may be configured to receive first liner interface 420. As shown in FIG. 4A, upper liner assembly 430 may include comfort section 433. Comfort section 433 may include padding to receive a user's head and/or back. Comfort section 433 may include one or more of massage device 434 and speaker 435. In some embodiments, comfort section 433 may include a heating element. Comfort section 433 may receive electrical power from a pool hub. Electrical power may be routed through upper liner assembly 430 and/or between outside liner 412 and inside liner 414. In some embodiments, Electrical power may be routed through a hollow frame of a pool assembly.

FIG. 4E illustrates exemplary step assembly 440. Step assembly 440 may include hub container 452 that encloses pool hub 448. Pool hub 448 may include features described elsewhere with relation to other pool hubs. Step assembly 440 may include at least one of bottom step 442, middle step 446, and top step 448. Bottom step 442 may include lip recess 442 and first hub recess 456. First hub recess 456 may receive a portion of pool hub 448. Step assembly 440 may include lip support 444. Lip support 444 may fit within lip recess 458. Lip support 444 and lip recess 458 may operate in conjunction to transfer force, such as from a weight of a user, from middle step 446 to bottom step 442. Middle step 446 may include second hub recess 454. Second hub recess may receive a portion of pool hub 448. Hub container 452 may connect top step 448 to middle step 446. Hub container 452 may transfer force, such as a weight of a user, from top step 448 to middle step 446. In some embodiments, one or more steps may comprise a polymer or PVC material. Pool hub 448 and downstream components electrically connected to pool hub 448 may receive direct or indirect power via electrical connection 450.

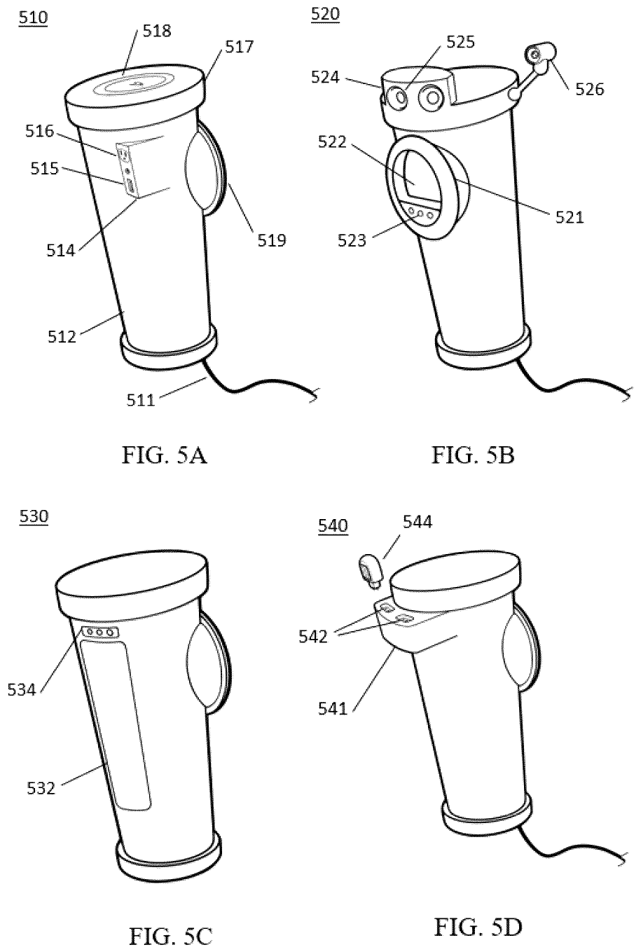

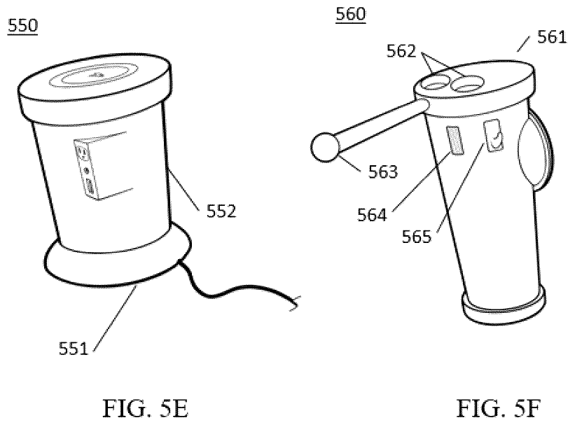

FIGS. 5A-5F illustrate another exemplary pool assembly 500, in accordance with some embodiments of the present disclosure. Certain features of pool assembly 500 are not shown or discussed in these examples where such features may be similar to those discussed for other embodiments.

FIG. 5A illustrates exemplary pool hub 510. Pool hub 510 may include one or more of electrical connection 511, body 512, outlets 514, lid 517, charging station 518, and pool interface 519. Pool hub 510 and downstream components such as outlets 514 may receive direct or indirect power from electrical connection 511. Outlets 514 may protrude from body 512 to prevent liquid accumulation. In some embodiments, outlets 514 may be angled from a vertical position so that liquid may be directed away from outlets 514. Outlets 514 may include one or more of USB port 515, electrical outlet 516, an auxiliary cable, or a number of other interfaces with external devices consistent with the present disclosure. Lid 517 may be removable from body 512 such that a user may access the inside of body 512, for example, to change a filter, to add chemicals, to remove debris, etc. Lid 517 may include induction charger 518. Induction charger 518 may be configured to provide electrical power to portable power devices through induction coupling.

FIG. 5B illustrates exemplary pool hub 520. Pool hub 520 may include one or more of pool interface 521, speaker protrusion 524, and optical sensor 526. Pool interface 521 may include seal 521, inlet 522, and light 523. Seal 521 may be configured to keep liquid inside of a pool. Light 523 may provide a light towards the interior of the pool. Light 523 may include one or more of a LED and a LED light string. Light 523 may indicate a status of a pump of pool hub 520, such as a filter status.

Optical sensor 526 may include a camera. Optical sensor 526 may include an infrared sensor. Optical sensor 526 may include a laser rangefinder.

FIG. 5C illustrates exemplary pool hub 530. Pool hub 530 may include one or more of panel 532 and light 534. Panel 532 may be substantially transparent to allow a user to view a filter within pool hub 530. In some embodiments, pool hub 530 may include internal lights that allow a user to see within pool hub 530, for example, to view the filter. Light 534 may indication a status of a pump of pool hub 530, such as a filter status. It is also contemplated that a lid or a body surface of pool hub 530 may be substantially transparent.

FIG. 5D illustrates exemplary pool hub 540. Pool hub 540 may include protrusion 541. Protrusion 541 may include outlets 542. Outlets 542 may be configured to attach to device 544. Device 544 may be configured to wirelessly connect with one or more programs to send/receive instructions associated with pool hub 540 and/or one or more devices connected to pool hub 540.

FIG. 5E illustrates exemplary pool hub 550. Pool hub 550 may include body 552 and base 551. Body 552 may be attachable to base 551. Pool hub 550 may be portable. Pool hub 550 may be configured to stand by itself on a ground surface.

FIG. 5F illustrates exemplary pool hub 560. Pool hub 560 may include one or more physical components including lid 561, cupholders 562, rack 563, magnetic connection surface 564, and hanger 565.

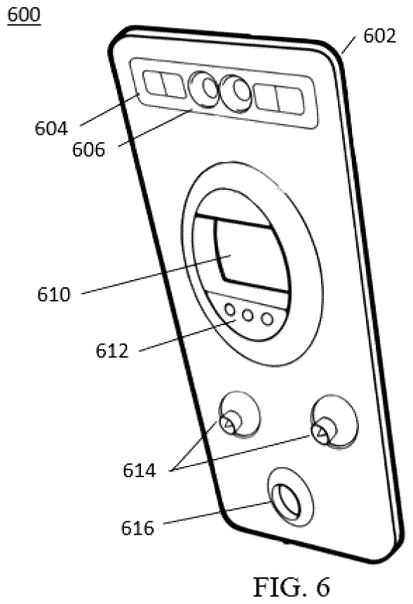

FIG. 6 illustrates exemplary pool interface 600, in accordance with some embodiments of the present disclosure. Certain features of pool interface 600 are not shown or discussed in these examples where such features may be similar to those discussed for other embodiments. Pool interface 600 may include sealing plate 602. Sealing plate 602 may include one or more of touch interface 604, speakers 606, inlet 610, light 612, jets 614, and outlet 616. Touch interface 604 may be configured to receive input from a user associated with a pool hub or one or more devices associated with the pool hub.

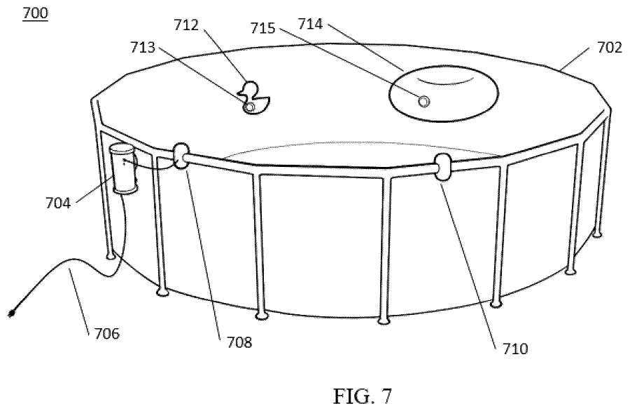

FIG. 7 illustrates another exemplary pool assembly 700, in accordance with some embodiments of the present disclosure. Certain features of pool assembly 700 are not shown or discussed in these examples where such features may be similar to those discussed for other embodiments. Pool assembly 700 may include pool 702 and pool hub 704. Pool assembly 700 may include one or more of electrical connection 706, first sensor 708, second sensor 710, toy 712, and float 714. First sensor 708 may receive power and/or data through a wired connection with pool hub 704. First sensor 708 may be configured to detect an object, such as a person, toy, or float, inside pool 702. First sensor 708 may be configured to determine if liquid of pool 702 is moving such as to impact first sensor 708. First sensor 708 may include an optical sensor configured to determine if moving objects are in or near pool 702. First sensor 708 may include an infrared sensor to detect a temperature of an item in or near pool 702.

Second sensor 710 may receive power and/or data through a wireless connection with pool hub 704. Second sensor 710 may include a battery. Second sensor 710 may be configured to detect an object, such as a person, toy, or float, inside pool 702. Second sensor 710 may use the same detection method as first sensor 708 or a different detection method.

Toy 712 may be configured to send a signal that may be detected by pool hub 704 and/or one or more sensors 708, 710. Toy 712 may include an identifier 713. Identifier 713 may include an RFID chip. Identifier 713 may be configured to be a passive or active emitter such that toy 712 may be identified, for example, based on a designation associated with a known object. Identification 713 may be powered by a battery and may transmit a wireless signal to pool hub 704 and/or one or more sensors 708, 710. Identifier 713 may be configured to provide the position of toy 712 to one or more sensors 708, 710. In some embodiments, toy 712 may be powered. In some embodiments, toy 712 may include a motor such as an electric motor so that it may move. In some embodiments, toy 712 may be sensitive to electric shock. In some embodiments, toy 712 may be configured to respond to a user's touch such as to change an operation status of a motor or an emission state of a light. Toy 712 may include a physical sensor, for example, that measures acceleration or movement of toy 712. Toy 712 may include a sensor that measures whether toy 712 is submerged under a liquid. Toy 712 may include other sensors consistent with the present disclosure.

Float 714 and float identifier 715 may include similar features related to toy 712 and toy identifier 713. Float 714 may be configured to detect whether a user is using float 714. Float 714 may be configured to determine whether float 714 is inside the perimeter of the pool. Float 714 may be configured to provide a notification of whether float 714 is in use. Float 714 may be configured to provide a notification of a change in the use of float 714. Float 714 may be configured to provide a notification if one or more portions of float 714 become submerged.

Although embodiments related to one or more sensors, a float, and a toy are discussed here, other embodiments consistent with this disclosure are envisioned such as a basketball, an entertainment board such as a score board, an egress/ingress system such as a ladder, a floating mattress, a floating fountain, water projectile systems, and other pool apparatuses. It is envisioned that some sensors may be configured to track one or more users of a pool and/or pool apparatuses for safety.

Pool hub 704 may include one or more processors configured to control and/or receive signals from one or more sensors, floats, toys, and/or pool apparatuses. Although pool hub 704 may include such processors, it is also envisioned that a control center may be separate from pool hub 704 that is configured to control and/or receive signals from one or more sensors, floats, toys, and/or pool apparatuses. The one or more processors may be configured to track a score associated with a game played with the toys. The one or more processors may be configured to provide lights and sounds in conjunction with the game. The one or more processors may be configured to track the position of one or more toys and/or floats. The one or more processors may be configured to receive instructions associated with the game such as from an external communication device. The instructions may include parameters associated with the game such as a time, a number of laps, a distance, a sound preference, or other such parameters.

As an example of an operation of pool hub 704, pool hub 704 may be configured to receive a signal of a noise of a user. Pool hub 704 may be configured to transmit a signal to a toy, such as toy 712, to emit a sound in response to the noise. Pool hub 704 maybe be configured to emit sound and/or lights when the toy is touched by the user. As another example of an operation of pool hub 704, pool hub 704 may be configured to track a user swimming in the pool such that it emits a noise when a lap has been completed, where the lap may be a distance between two sensors, a perimeter of a pool as determined by multiple sensors, or a single sensor that senses movement near the sensor in a sequential manner. As another example of an operation of pool hub 704, pool hub 704 may be configured to track multiple users and announce when one user has completed a lap.

An alert system associated with pool hub that includes one or more processors may receive detection information from one or more of first sensor 708, second sensor 710, toy 712, and/or float 714. The alert system may compare detection information from different sensors to determine whether a detection is a false alarm. The alert system may be configured to differentiate an object from a person based on one or more parameters. The one or more parameters may be a movement of an object over a period of time, a displacement of an object, a temperature associated with an object, whether more than one sensor detects an object within a period of time, an electrical charge associated with an object, or a size of an object. When an object is detected and determined to meet one or more of the parameters, such as if the object is a human, the alert system may send a wireless signal to a communication device that communicates the presence of the object. In some embodiments, the alert system may turn on a camera and send an image or video from the camera to the communication device. The alert system may also activate a speaker and/or a light associated with pool assembly 700, for example, to alert nearby persons.

In some embodiments, pool hub 704 may include a voice-activation system so that one or more devices associated with pool hub 704 may be controlled via voice commands. For example, an alarm system, a speaker system, and/or a light system may be controlled via voice commands.

In some embodiments, a pool toy may be wirelessly connected to pool hub 704 to receive instructions from pool hub 704. For example, the pool toy may receive commands to activate a sound system, a light, or a movement apparatus associated with received instructions. In some embodiments, one or more pool toys may be wirelessly connected with pool hub 704 and pool hub 704 may track one or more of displacement, speed, and/or position of the pool toys. In some embodiments, pool hub 704 may use a speaker system to announce pre-programmed messages associated with the pool toys. For example, the pre-programmed messages may be used to announce a beginning of a race and/or and end of a race.

Instructions associated with pool hub 704 may be managed via computer program consistent with the present disclosure. A communication device may operate the computer program to send/receive instructions associated with pool hub 704. For example, the computer program may be configured to display alarm information on the communication device, where the alarm information is associated with received instructions or data from pool hub 704. As a further example, the computer program may be configured to send instructions to pool hub 704 to turn off the alarm system. As a further example, the computer program may be configured to display information received from pool hub 704 that reflects a status of pool hub 704. In such embodiments, the status may be an on/off status, a filter status, a chemical composition status, or a pH status.

In some embodiments, pool assembly 700 may include a roof. The roof may be a retractable roof. The roof may include one or more solar panels. The roof may include one or more sensors consistent with this disclosure. Further, the one or more roof sensors may sense whether a roof is open or closed. The roof may receive power to open or close a roof from pool hub 704. In some embodiments, a computer program associated with pool hub 704 may be configured to open or close a roof.

In some embodiments, pool assembly 700 may include a pool cover. The pool cover may be a retractable pool cover. The pool cover may include one or more solar panels. The pool cover may include one or more sensors consistent with this disclosure. Further, the one or more pool cover sensors may sense whether a pool cover substantially covers a liquid of a pool. A mechanism of the pool cover may receive power to spread and/or retract a pool cover. In some embodiments, a computer program associated with pool hub 704 may be configured to spread/retract the pool cover.

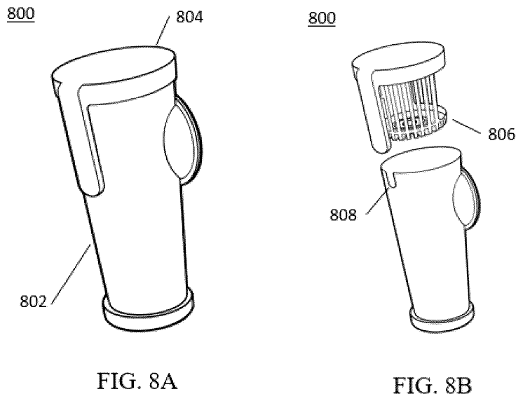

FIGS. 8A-8B illustrate another exemplary pool hub 800, in accordance with some embodiments of the present disclosure. Certain features of pool assembly 800 are not shown or discussed in these examples where such features may be similar to those discussed for other embodiments.

FIGS. 8A-8B illustrate exemplary pool hub 800 in accordance with some embodiments of the present disclosure. Certain features of pool assembly 800 are not shown or discussed in these examples where such features may be similar to those discussed for other embodiments. Pool hub 800 may include body 802 and lid 804. Lid 804 may be attachable to filter 806 such that when lid 804 is lifted, the filter moves with lid 804. Body 802 may include notch 808 to secure lid 804 to body 802. For example, lid 804 may be position in a desired orientation when an elongated portion, such as a handle, of lid 804 aligns with notch 808.

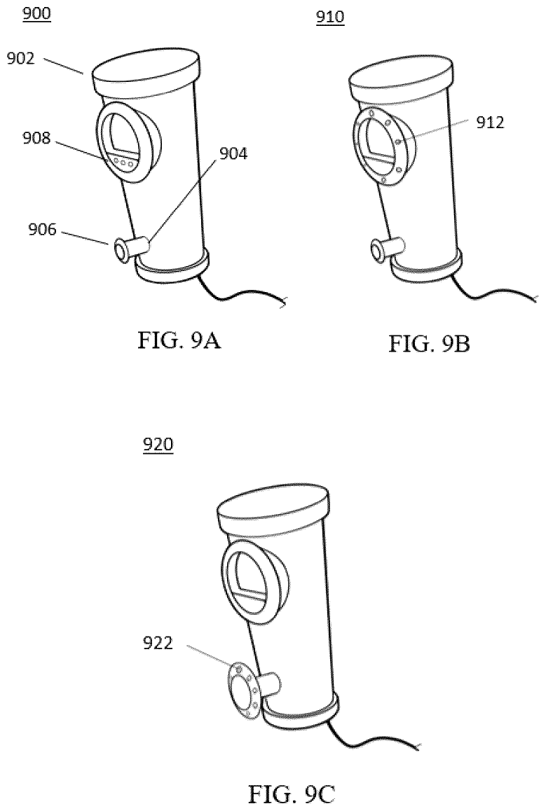

FIGS. 9A-9C illustrates other exemplary pool hubs in accordance with some embodiments of the present disclosure. Certain features of pool exemplary pool hubs in FIGS. 9A-9C are not shown or discussed in these examples where such features may be similar to those discussed for other embodiments. FIG. 9A illustrates pool hub 900 in accordance with some embodiments of the present disclosure. Pool hub 900 may include inlet 902 and outlet 904. Inlet 902 and outlet 904 may be connectable to respective apertures in a pool liner. In some embodiments, inlet 902 and outlet 904 may be connectable so as to support a weight of pool hub 900. In some embodiments, other physical connections may be used to support a weight of pool hub 900. In some embodiments, pool hub 900 may stand on a ground surface.

Outlet 904 may include seal 906 that seals with a pool, for example with a pool liner of the pool, so that liquid may be transferred from pool hub 900 to the pool without leaking. Liquid may be processed by pool hub 900 by being input into inlet 902 and exiting through outlet 904. In some embodiments, such processing may include one or more of water filtration, mixing chemicals into the liquid, heating the liquid, or other such processing consistent with the present disclosure. Pool hub 900 may include a light 908. Light 908 may include an LED. Light 908 may include an LED light string. One advantage associated with pool hub 900 is the combination of inlet and outlet on one body which may reduce a number of components, provide less components to assembly, and/or prevent leaking.

FIG. 9B illustrates pool hub 910 in accordance with some embodiments of the present disclosure. Pool hub 910 may include outlet light 912. FIG. 9C illustrates pool hub 920 in accordance with some embodiments of the present disclosure. Pool hub 920 may include inlet light 922.

While the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. For example, in various aspects of the disclosure, methods and compositions were described according to aspects of the presently disclosed subject matter. In particular, aspects of the present disclosure have been described as relating to systems and methods for providing a pool hub. Additionally, other equivalent methods or composition to these described aspects are also contemplated by the teachings herein. Therefore, the present disclosure should not be limited to any single aspect, but rather construed in breadth and scope in accordance with the appended claims.

What is claimed is:

1. A pool hub comprising:
a power hub configured to receive electric power;
a pump configured to receive electric power from the power hub, wherein the pump is configured to seal fluid from the power hub; and
an electrical outlet configured to receive electric power from the power hub,
wherein the electrical outlet is configured to provide power to an electronic accessory.

2. The pool hub of claim 1, wherein the power hub comprises a ground fault circuit interrupter.

3. The pool hub of claim 1, wherein the electrical outlet comprises a ground fault circuit interrupter.

4. The pool hub of claim 1, wherein the electronic accessory comprises an electrically-powered retractable roof.

5. The pool hub of claim 1, wherein the electronic accessory comprises a retractable ladder.

6. The pool hub of claim 1, wherein the electronic accessory comprises a charging base.

7. The pool hub of claim 1, wherein the power hub receive powered from a solar panel.

8. The pool hub of claim 7, wherein the solar panel comprises a pool cover.

9. The pool hub of claim 1, wherein the electronic accessory comprises a temperature sensor that senses a temperature of water in the pool.

10. The pool hub of claim 1, wherein the electronic accessory comprises a sensor that indicates a movement associated with the pool.

11. The pool hub of claim 1, wherein the electronic accessory comprises an acidity sensor that senses an acidity of water in the pool.

12. The pool hub of claim 10, wherein the electronic accessory comprises a light that indicates the acidity of water in the pool.

13. The pool hub of claim 10, wherein the electronic accessory comprises a light that indicates a filter status.

14. The pool hub of claim 1, the pool hub further comprising a skimmer.

15. The pool hub of claim 1, the pool hub further comprising a heating element.

16. The pool hub of claim 1, the pool hub further comprising a controller that sends or receives information from the pump.

17. The pool hub of claim 16, wherein the controller is configured to communicate remotely with a network device.

18. The pool hub of claim 17, wherein the controller is configured to receive instructions from the network device.

19. The pool hub of claim 1, wherein the electronic accessory comprises an air supply station.

20. A pool hub comprising:
a primary electrical system configured to provide electrical power to a pump;
a secondary electrical system configured to receive electrical power from the primary electrical system;
a converter; and
an electrical outlet configured to receive power from the secondary electrical system;
wherein the converter distributes power from the primary electrical system to the secondary electrical system.

21. The pool hub of claim 20, wherein the primary electrical system comprises a

22. The pool hub of claim 20, wherein the primary electrical system comprises a direct current system.

23. The pool hub of claim 20, wherein the primary electrical system comprises a battery.

24. The pool hub of claim 20, wherein the secondary electrical system comprises a 12V system.

25. The pool hub of claim 20, wherein the secondary electrical system comprises a controller that sends or receives information from an electronic accessory.

26. The pool hub of claim 25, wherein the controller is configured to communicate remotely with a network device.

27. The pool hub of claim 26, wherein the controller is configured to receive instructions from the network device.

28. The pool hub of claim 20, wherein the pump is configured to physically and electrically connect to a skimmer.

29. The pool hub of claim 20, wherein the secondary electrical system is insulated from the primary electrical system.

30. The pool hub of claim 20, wherein the pump comprises a filter.

31. The pool hub of claim 20, wherein the secondary electrical system comprises a light.

32. The pool hub of claim 20, wherein the secondary electrical system comprises a sound device.

33. The pool hub of claim 20, wherein the primary electrical system comprises a light.

34. The pool hub of claim 20, wherein the pump comprises an alarm.

35. The pool hub of claim 20, wherein the pump comprises a vacuum.

36. The pool hub of claim 20, wherein the pump comprises a jet system.

37. The pool hub of claim 36, wherein the secondary electrical system comprises a light that interacts with the jet system.
